(19) United States
(12) Patent Application Publication
(10) Pub. No.: US 2007/0030923 A1
(43) Pub. Date: Feb. 8, 2007

(54) High accuracy non data-aided frequency estimator for M-ary phase shift keying modulation

(76) Inventor: Xiaoming Yu, Cupertino, CA (US)

Correspondence Address: FELIX L. FISCHER, ATTORNEY AT LAW, 1607 MISSION DRIVE, SUITE 204, SOLVANG, CA, 93463, US

(21) Appl. No.: 11/196,233

(22) Filed: Aug. 2, 2005

(51) Int. Cl. H04L 27/22

(52) U.S. Cl. 375/332

(57) ABSTRACT

A method for non-data aided frequency offset determination for MPSK demodulation is accomplished by receiving a stream of K symbols and providing the symbol stream to a delay line of L symbols in length with L greater than 1. The symbol stream and an output of the delay line are then multiplied and the output of the multiplier is raised to the M power to remove modulation. The result is accumulated over K symbols and the argument of 1/K2πMLT times the accumulated result is determined as the frequency offset.

### BACKGROUND OF THE INVENTION

1. Field of the Invention

This invention relates generally to the field of telecommunications network transmission systems and, more particularly, to a non-data-aided frequency estimator for use in demodulation of M-ary phase shift keying (M-PSK) modulated signals.

2. Description of the Related Art

M-ary phase shift keying (M-PSK) modulation is widely used in communication systems. Among the most widely used M-PSK modulation schemes are binary phase shift keying (BPSK), quadriphase shift keying (QPSK), and their variations such as π/4 QPSK, differential QPSK. A representative explanation of these systems is disclosed in Y. Okunev, Phase and Phase-difference Modulation in Digital Communications, Artech House, 1997

For current exemplary systems, the second generation CDMA system uses BPSK while the third generation WCDMA system uses both BPSK and QPSK modulation. The PHS system uses π/4 differential QPSK.

It is often impractical or economically infeasible to maintain exact frequency synchronization between the transmitter and the receiver, as a result, accurate frequency estimation of the difference between the transmitted and received signals is desirable. This is especially true for coherent demodulation, for which highly accurate estimation is essential. Most prior art systems employ data-aided frequency estimation using training sequences embedded in message bursts. However, this technique uses bandwidth and may require additional complexity in the demodulation algorithms and hardware.

It is therefore desirable to provide a non-data-aided frequency estimator for M-PSK demodulation.

### SUMMARY OF THE INVENTION

The present invention provides a method for non-data aided frequency offset determination for MPSK demodulation accomplished by receiving a stream of K symbols and providing the symbol stream to a delay line of L symbols in length with L greater than 1. The symbol stream and an output of the delay line are then multiplied and the output of the multiplier is raised to the M power to remove modulation. The result is accumulated over K symbols and the argument of 1/K times the accumulated result is determined as the frequency offset.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the elements acting on a symbol input stream for an embodiment of the invention; and,

FIG. 2 is a block diagram of an exemplary hardware implementation of the embodiment of FIG. 1.

### DETAILED DESCRIPTION OF THE INVENTION

This invention applies to all types of MPSK modulation. In what follows, it is described using a MPSK modulation signal model.

Each symbol of a received M-PSK signal can be described in baseband complex format by the following equation:
S(k)=Cₖe^{j2π(f}^{_{c}}^{+f}^{₀}^{)kT+θ}+n(k) (1)

Where k represents the sample index and k=0,1, . . . K. f_{c} and f₀ are the carrier frequency and frequency offset respectively. T is the symbol duration. θ is the phase offset. n(k) is the white Gaussian noise, Cₖ is the data symbol belonging to the MPSK constellation

$${C}_{k} = {ⅇ}^{j \frac{2 πⅈ}{M}} \qquad ( 2 )$$

where 0≦k≦M−1

Many frequency estimation techniques have been developed for MPSK. Most are data-aided, i.e., some sort of training sequence is transmitted in addition to the information. On the receiver side, the known training sequence is used to estimate frequency offset.

Non-data aided frequency estimation does not need a training sequence. It takes into account of the fact that (Cₖ)^{M}=1 to effectively remove the modulation from a M-PSK signal. The modulation removed M-PSK signal can then be used for frequency estimation. Frequency estimation methods based on this concept is called none-data-aided frequency estimator. Non-data aided frequency offset estimator is highly desirable since it has high bandwidth efficiency due to the fact that it eliminates the need of training sequence.

One commonly used non data-aided frequency estimation method for M-PSK is proposed in J Chuang and N Sollenberger, Burst Coherent Demodulation with Combined Symbol Timing, Frequency Offset Estimation, and Diversity Selection, IEEE trans. Communications, pp 1157-1164, July 1991, which is described below.

Raising Equation (1) to the Mth power yields
[S(k)]^{M}=e^{f[2π(f}^{_{c}}^{+f}^{₀}^{)kT+θ]M}+n′(k) (3)

n′(k) is the noise term resulting from signal multiplied by noise and noise multiplied by noise. Modulation is removed in the equation. Next, multiplying [S(k)]^{M} by [S(k−1)]M, provides
[S(k)]^{M}·[S(k−1)]^{M}=e^{j2πMf}^{₀}^{T}+n″(k) (4)

Again n″(k) is the noise term resulting from signal multiplied by noise and noise multiplied by noise.

It is apparent that carrier frequency and phase are removed in Equation (4) so it can be used to estimate f₀. The estimation accuracy can be further improved by smoothing out the noise

$$\frac{1}{K} {\sum }_{k = 0}^{K - 1} ( {[ S ( k ) ]}^{M} \cdot {[ {S}^{*} ( k - 1 ) ]}^{M} ) = {ⅇ}^{j2π {Mf}_{0} T} + \frac{1}{K} {\sum }_{k = 0}^{K - 1} {n}^{″} ( k ) \qquad ( 5 )$$

In summary the frequency estimator is

$${f}_{0} = \frac{1}{2 π MT} arg \{ \frac{1}{K} {\sum }_{k = 0}^{K - 1} ( {[ S ( k ) ]}^{M} \cdot {[ {S}^{*} ( k - 1 ) ]}^{M} ) \} \qquad ( 6 )$$

The estimator described above is good for applications where moderate accurate frequency estimation is required such as differential PSK. However, for application where more accurate estimation is needed, such as coherent demodulation of M-PSK signal, it is not accurate enough.

The present invention provides a new frequency estimator, which is capable of estimating very small frequency offset. Instead of using S(k) and S(k−1), S(k) and S(k−L) are used, where L is larger than 1. The use of S(k) and S(k−L), when L is large, enables estimation of small frequency errors since the phase offset is accumulated over L symbol periods to 2πf₀LT instead of 2πf₀T.

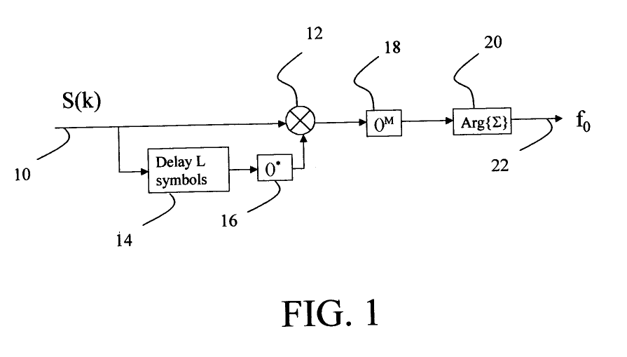

As shown in FIG. 1, the symbol input stream S(k) 10 is routed to a multiplier 12 and through delay line of L symbols 14 and conjugated 16. The delayed signal is multiplied and the result is raised to the M power in multiplier 18 [S(k)]^{M} times [S(k−L)]M, to provide
[S(k)]^{M}·[S*(k−L)]^{M}=e^{j2πMLf}^{₀}^{T}+n″(k) (7)

where n″(k) is the noise term resulting from signal multiplied by noise and noise multiplied by noise.

Similar to Equation (4), we can use Equation (7) to estimate f₀. The estimation accuracy can be further improved by smoothing out the noise as well

$$\frac{1}{K} {\sum }_{k = 0}^{K - 1} ( {[ S ( k ) ]}^{M} \cdot {[ {S}^{*} ( k - L ) ]}^{M} ) = {ⅇ}^{j2π {MLf}_{0} T} + \frac{1}{K} {\sum }_{k = 0}^{K - 1} {n}^{″} ( k ) \qquad ( 8 )$$

The offset frequency is then estimated as

$${f}_{0} = \frac{1}{2 π MLT} arg \{ \frac{1}{K} {\sum }_{k = 0}^{K - 1} ( {[ S ( k ) ]}^{M} \cdot {[ {S}^{*} ( k - L ) ]}^{M} ) \} \qquad ( 9 )$$

The frequency offset 22 is obtained by operating on the output of the exponent multiplier with 1/2πMLT times the argument of 1/K times the sum over K symbols in accumulator 20. The frequency offset determination is usually accomplished for each burst. Frequency change during each burst is usually very small, however, should situations arise where frequency change is anticipated during symbol bursts, this method can be used multiple times during a burst.

The performance of this frequency estimation method depends on K, the number of samples, as well as L, the interval between the adjacent samples. The estimator of the present invention collapses to the estimator described in Chuang and Sollenberger by letting L equal 1.

K and L of large value will give more accurate estimation. However, it should be noted that the frequency offset that can be estimated must satisfy MLTf₀<1, otherwise the e^{j2πMLf}^{₀}^{T} term in Equation (7) will wrap around and produce incorrect results.

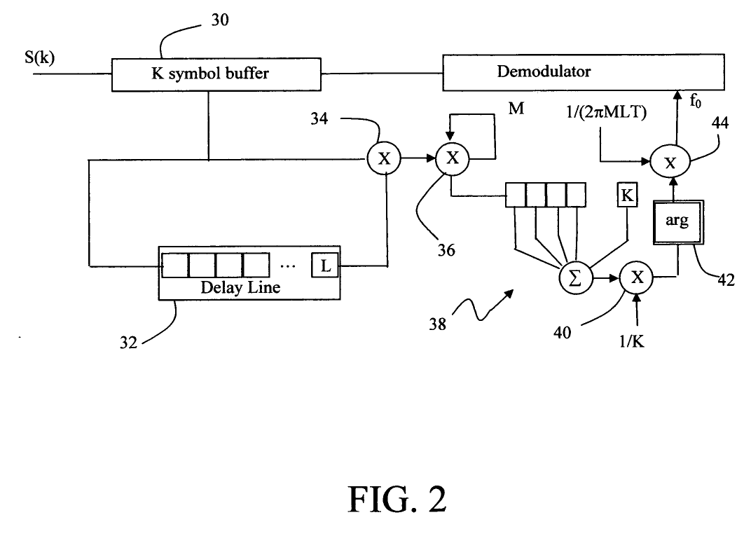

An implementation of the frequency offset estimator according to the present invention is shown in FIG. 2. The frequency offset estimator for MPSK demodulation includes a buffer 30 for receiving a stream of K symbols. A delay line 32 of L symbol lengths where L is greater than 1 is connected to the buffer and a multiplier 34 receives a first input from the buffer and a second input from the delay line. The output of the multiplier is raised to the M power using a multiplier string 36 and an accumulator 38 receives the result for K symbols. A 1/K multiplier 40 acts on the output of the accumulator and the argument of the output of the 1/K multiplier is determined as the frequency offset. For the embodiment shown, the argument function is obtained using a look-up table 42. A multiplier 44 on the output provides the required 1/2πMLT factor. The buffer symbol data is then adjusted by the frequency offset for demodulation of the symbol burst.

Compared with existing non-data-aided frequency estimators, this method is capable of providing high accuracy estimation if the frequency offset is relatively small. This frequency estimator is applicable to all wireless standards using MPSK modulation, such as PHS, CDMA, WCDMA, CDMA2000.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A method for non-data aided frequency offset determination for MPSK demodulation comprising the steps of:
receiving a stream of K symbols;
providing the symbol stream to a delay line of L symbols in length with L greater than 1;
multiplying the symbol stream and an output of the delay line;
raising the output of the multiplier to the M power;
accumulating the result over K symbols;
determining the argument of 1/K times the accumulated result to determine the frequency offset; and,
multiplying the argument by 1/2πMLT.

2. A method as defined in claim 1 wherein the step of multiplying includes the step of obtaining the complex conjugate of the delayed symbols.

3. A frequency offset estimator for MPSK demodulation comprising:
means for receiving a stream of K symbols;
a delay line of L symbol lengths where L is greater than 1 connected to the receiving means;
a multiplier receiving a first input from the receiving means and a second input from the delay line;
means for raising an output of the multiplier to the M power to provide a result;
an accumulator receiving the result for K symbols;
a 1/K multiplier acting on an output of the accumulator;
means for determining the argument of an output of the 1/K multiplier; and,
a multiplier for 1/2πMLT times an output of the determining means.

4. A frequency offset estimator as defined in claim 3 wherein the means for determining the argument comprises a look-up table.
